(19) United States
(12) Patent Application Publication
(10) Pub. No.: US 2014/0122195 A1
(43) Pub. Date: May 1, 2014

(54) Systems and Methods for Tracking and Analyzing the Redemption of Promotional Content

(71) Applicant: STERLING GLOBAL SOLUTIONS, INC., Atlanta, GA (US)

(72) Inventors: Catherine M. Tabor, Atlanta, GA (US); Terry Bruehl, Atlanta, GA (US); Ken R. Powell, Watkinsville, GA (US); John W. Daniel, Bogart, GA (US)

(73) Assignee: STERLING GLOBAL SOLUTIONS, INC., Atlanta, GA (US)

(21) Appl. No.: 13/660,444

(22) Filed: Oct. 25, 2012

(51) Int. Cl. G06Q 30/02

(52) U.S. Cl. 705/14.13

(57) ABSTRACT

Certain embodiments herein are directed to tracking and analyzing the redemption of promotional content, such as coupons, discounts, or similar offers. The redemption of the promotional content may be tracked such that a source or provider of the promotional content may be identified and associated with the promotional content at the point of redemption. Requests to redeem promotional content may be verified by comparing information received at the point of redemption with information previously stored in association with providing promotional content to a user device seeking to redeem the promotional content. Such information may include a unique identifier for the promotional content, a unique identifier for the user device, and a unique identifier for the source of the promotional content. Information associated with historical redemptions of promotional content may be analyzed to target user devices and/or sources of the promotional content for receiving future distributions of the promotional content.

### TECHNICAL FIELD

Embodiments of the disclosure relate generally to promotional content and, more particularly, to the redemption of promotional content.

### BACKGROUND

Promotional content, such as discounts, coupons, or similar offers, may provide incentives for consumers to purchase items or services associated with the promotional content. Manufacturers of such items or services, for example, may distribute promotional content to various sources, such as web servers hosting web sites for displaying promotional content, where they may be accessed by potential consumers. Such distribution efforts may be time-consuming, costly, and difficult to measure in terms of their effectiveness, since much of promotional content that is distributed may not be utilized by consumers. A major contributor of such shortcomings may be attributed to the inability of existing systems to track the redemption of distributed promotional content. For example, a source, or provider of promotional content that is ultimately redeemed, may be unknown at the point of redemption. Manufacturers or other entities that may benefit from such information may therefore struggle to evaluate the alternative distribution means for promotional content delivery and evaluate the effectiveness of targeted distribution, distribution cost, and promotional program efficiency.

### BRIEF DESCRIPTION OF THE DISCLOSURE

Some or all of the above needs and/or problems may be addressed by certain embodiments of the invention. Embodiments of the disclosure may include systems and methods for tracking and analyzing information associated with redeemed promotional content. According to one embodiment, there is disclosed a system including at least one memory and at least one processor configured to execute computer-executable instructions in the memory to store first information associated with a distribution of promotional content to a user device, wherein the first information comprises an identifier that identifies a source from which the user device received the promotional content; receive from one or more POS devices, a request to redeem promotional content, wherein the request comprises second information associated with the promotional content; verify the request based at least in part on a comparison between at least a portion of the first information and at least a portion of the second information; determine that the request is valid; receive, from the one or more POS devices, a first indication that an item or service associated with the promotional content was consumed; and in response to receiving the first indication, storing at least a second indication that the promotional content was redeemed.

According to another embodiment, there is disclosed one or more computer-readable media storing computer-executable instructions that, when executed by at least one processor, configure the at least one processor to perform operations. Such operations include receiving, from a user device, a first identifier identifying promotional content, a second identifier identifying a source at which the promotional content was identified, and a third identifier identifying the user device, wherein the first identifier, the second identifier, and the third identifier were received by the user device in association with the user device requesting the promotional content; sending, to a service provider device, a request to verify the promotional content, the request comprising the first identifier, the second identifier, and the third identifier; and receiving, from the service provider device, a status message based at least in part on the verification request.

According to a further embodiment, there is disclosed a method for receiving, by a service provider system comprising one or more computing devices, from a user device, a request to receive promotional content; determining, by the service provider system, a first identifier associated with the promotional content, a second identifier associated with the user device, and a third identifier associated with a source at which the user device identified the promotional content; storing, at the service provider system, the first identifier, the second identifier, and the third identifier; receiving, at the service provider system, a request to redeem the promotional content, wherein the request comprises a unique identifier identifying the promotional content; verifying, by the service provider system, the request based at least in part on a comparison between the unique identifier and the first identifier; receiving, at the service provider system, a first indication that an item or service associated with the promotional content is being consumed; and in response to the first indication, storing, by the service provider system, a second indication that the promotional content was redeemed.

### BRIEF DESCRIPTION OF THE FIGURES

FIG. 1 illustrates an example computing environment for tracking and analyzing the redemption of promotional content, according to one embodiment of the disclosure.

FIG. 2 illustrates an example schematic diagram of a process for distributing promotional content, according to one embodiment of the disclosure.

FIG. 3 illustrates an example flow diagram of a process for facilitating the redemption of promotional content, according to one embodiment of the disclosure.

FIG. 4 illustrates an example flow diagram of a process for determining one or more target lists for distributing promotional content, according to one embodiment of the disclosure.

FIG. 5 illustrates an example flow diagram of a method for capturing information associated with requesting promotional content, according to an embodiment of the disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers refer to like elements throughout.

### DETAILED DESCRIPTION

Illustrative embodiments herein are directed to, among other things, tracking and analyzing the redemption of promotional content. As used herein, promotional content may refer to information that may promote the purchase of goods or services by incentivizing consumers to purchase the goods or services in association with discounts or savings associated with the promotional content. Examples of promotional content may include, but are not limited to, coupons, discounts, banner advertisements, challenge-response inquiries in which a consumer may receive a discount or savings upon responding correctly to an inquiry, or other savings opportunities that may afford consumers with savings on certain goods or services. Promotional content may be redeemed, for example, when promoted items or services are purchased and promotional content requirements are fulfilled or utilized in association with purchasing goods or services according to the terms, requirements, or other information associated with the promotional content.

Manufacturers, merchants, or other providers of goods or services may offer a variety of promotional content to incentivize consumers to purchase goods or services. Consumers may benefit from such savings by redeeming the promotional content at a merchant location or other location that may provide the goods or services. An example of redeeming promotional content may include a consumer utilizing a mobile device to present a coupon to a point-of-sale (POS) device at a merchant location to purchase an item, group of items, or services identified in the coupon at a discount. The redemption of the promotional content may be tracked such that a source, such as an entity hosting a website from which the consumer received the promotional content, may be identified and associated with the promotional content at the point of redemption. In this way, the source of each promotional content that is redeemed may be known. Additional information may also be tracked at the point of redemption of promotional content, such as an identifier associated with a mobile device and/or user account that received the promotional content, and an identifier uniquely identifying the promotional content. Other information, some of which is described below, may also be captured for each redemption of promotional content. Such information may be leveraged to develop a more personalized, cost-effective process for distributing or utilizing promotional content.

A more personalized, cost-effective process for distributing or utilizing promotional content may be accomplished at least in part by analyzing data associated with historical redemptions of promotional content. In so doing, target lists of consumers and/or sources or distributors of promotional content may be identified for disseminating certain promotional content. For example, consumers who may have previously redeemed a certain amount/number of a particular promotional content may receive future distributions of the same or similar promotional content, as well as related promotional content. Similarly, sources of the promotional content, such as an entity operating a website that provides promotional content to consumers, may be targeted for promotional content distribution based on an amount of promotional content received from the source and subsequently redeemed. A manufacturer of a particular item may, for example, leverage such redemption information to determine which sources of promotional content are more profitable or effective than others, e.g., based on an amount of promotional content that was distributed to consumers, such as the number of downloads from their websites, and subsequently redeemed. As mentioned, such determinations may be made by virtue of tracking information such as the source of promotional content (e.g., a website address and/or source identifier), an identifier of a user device utilizing the promotional content, and an identifier uniquely identifying the promotional content, among other information.

An example of tracking and analyzing information associated with the redemption of promotional content may be as follows. A central device in communication with various other devices via one or more networks may send promotional content to web servers hosting websites, such as the sportswebsite.com and travelwebsite.com websites, for distribution to consumers. The selection of such web servers may be based on analysis of historical information associated with the redemption of promotional content that indicates that distributing to these websites presents a better return on investment (ROI), in one embodiment. A user may utilize an application on a user device (e.g., a smart phone or tablet computer) to browse various websites, including sportswebsite.com and travelwebsite.com. As an example, while viewing a webpage at travelwebsite.com, a user may be presented with a link associated with the promotional content that enables the user to request a coupon for 20% off of a steak entrée at a particular restaurant by selecting the link on the travelwebsite.com website.

Upon selecting the link to receive the coupon, various information associated with the coupon, the user device, and the source (e.g., travelwebsite.com) may be captured and stored at the central device. Such information may include, but is not limited to, a unique identifier for the coupon, a unique identifier for the user device, and the Uniform Resource Locator (URL) associated with the website address (e.g., travelwebsite.com/coupons) that provided the promotional content. User-specific information associated with a user utilizing the user device may also be included. For example, as part of receiving or redeeming the promotional content, the user may be prompted to authenticate at a website associated with the central device by providing a user name and password. Upon authenticating, various information associated with the user may be identified, such as the user's purchase history, preferences for certain promotional content, demographic information, as well as other information that may be utilized to develop personalized offers for the user. Such information may be requested from a user in addition to, or alternative to, the user authenticating at the central device before the user may receive promotional content, in one embodiment. In one example, such information may be requested as a result of the user's not yet establishing a valid user account or the user failing to successfully authenticate at the website associated with the central device.

After receiving the coupon at a user device, a user may redeem the coupon at a merchant or other location that accepts the coupon. An application on the user device may present the coupon (e.g., in the form of a bar code that includes a unique identifier for the coupon or via another code that is unique to the user) such that it may be scanned by a POS device, input by a salesperson, or input via various other means such as those that may utilize a near field communication (NFC) signal or user biometric data, as non-limiting examples. Upon receiving a request to redeem the coupon, a POS device, e.g., via one or more software modules, may receive the unique identifier for the coupon and various additional information associated with redeeming the coupon, as described below. The POS device, or a device associated therewith, may establish a connection to the central device and transmit the unique identifier for the coupon, item level purchase information for goods and services being purchased, as well as other information, to the central device for verification, offer terms compliance, storage, and/or subsequent processing and analysis.

Before promotional content may be redeemed, according to one embodiment, it may be verified by the central device to ensure, for example, that the details associated with the promotional content as generated and/or distributed match the details of the promotional content as redeemed. In the present example, verifying the restaurant coupon may include validating that the unique identifier associated with the coupon does indeed relate to a 20% discount off of a steak entrée at the indicated restaurant and that the consumer is purchasing such items (e.g. steak entrée). A discount of a different percentage, for a different type of entrée, at a different restaurant or place of business, etc., may fail validation, which may result in the central device sending a response message to the POS device, or another device associated with the POS device, that the request to redeem the coupon is invalid. If the promotional content details above match, then a determination may be made by the central device that the redemption request is valid and various information may be sent to the POS device, or associated device, in response. Such information may include, but is not limited to, a purchase price or the discount amount associated with an item identified in the promotional content and additional promotional content that may be related to the redeemed promotional content.

In the present example, the central device may return a purchase price of $40 for a $50 steak dinner (e.g., after calculating a 20% discount off of the $50 dinner) or alternatively the central device may return $10 off of the steak dinner. Additionally and/or alternatively, promotional content associated with a coupon for a steak knife from an affiliate of the restaurant may be provided to the user. Numerous other types of coupons or promotional content may be provided in other examples. In this way, promotional content may be unlocked, or made available to users, to reward the users for their previous redemptions of certain promotional content.

As described above, information associated with promotional content may be stored and analyzed to determine target lists, profitability (e.g., a return on investment), and various other determinations, some of which are described below. For example, because the user received the restaurant coupon from the travelwebsite.com website, the travelwebsite.com website may be targeted for future distributions of the restaurant coupon, and/or related coupons or promotional content. If the sportswebsite.com website does not receive any requests from users for the restaurant coupon, for the purposes of illustration, then sportswebsite.com may not receive future distributions of the restaurant coupon. Thus, the restaurant offering the steak entrée promotion, for example, may focus its efforts by targeting sources more likely to produce redemption of the promotional content.

The above descriptions and examples are non-limiting. Numerous other examples involving different promotional content and/or devices, for example, may exist in other embodiments.

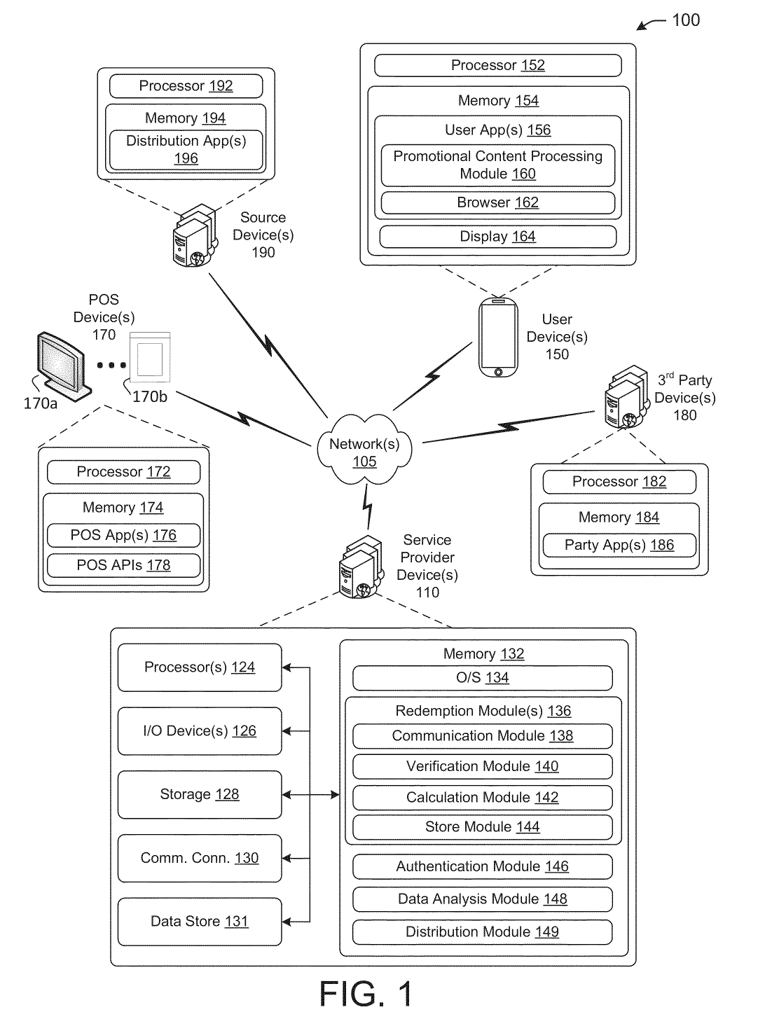

FIG. 1 depicts an example computing environment 100 for tracking and analyzing the redemption of promotional content, according to one embodiment of the disclosure. The computing environment 100 may include, but is not limited to, one or more service provider devices 110, one or more user devices 150, one or more point-of-sale (POS) devices 170, one or more third party devices 180, and one or more source devices 190. Each of these devices may communicate with one another via one or more networks 105 to facilitate the processes described herein. For example, a service provider device 110 may receive promotional content from a third party device 180 and communicate the promotional content to one or more source devices 190 and/or user devices 150. One or more POS devices device 170 that receive a request to redeem the promotional content from the user device 150 may send the request to the service provider device 110 for verification. Such a request from the one or more POS devices 170 may include an identifier for the promotional content, the items or services being purchased, and other information. The service provider device 110 may analyze such information and provide a response to the request for redemption to the one or more POS devices 170. In one embodiment, the one or more POS devices 170 may operate as a POS system in which promotional content or other information may be received as input (e.g., via a keyboard, NFC communication, bar code scanner or reader, other forms of electronic input, etc.) and communicated between multiple devices that may implement or facilitate the processes described herein. One or more POS devices 170 may also be used to calculate a total amount due associated with purchasing items or services, as non-limiting examples. Numerous other examples of communication between the devices in the computing environment 100 may exist in other embodiments, some of which are described below.

As used herein, the term “device” may refer to any computing component that includes one or more processors that can be configured to execute computer-readable, computer-implemented, or computer-executable instructions. Example devices can include personal computers, server computers, digital assistants, smart phones, personal digital assistants, digital tablets, Internet appliances, application-specific circuits, microcontrollers, minicomputers, transceivers, customer premise equipment such as set-top boxes, kiosks, or other processor-based devices. The execution of suitable computer-implemented instructions by one or more processors associated with various devices may form special purpose computers or other particular machines that may facilitate tracking and analysis of promotional content as described herein.

As used herein, the term “consume,” “consumed,” “consumption,” or similar, may refer to purchasing, using, leasing, winning, listening to, etc., items or services associated with promotional content.

The one or more networks 105 may include any number of wired or wireless networks that may enable various computing devices in the example computing environment 100 to communicate with one another. In other embodiments, other networks, intranets, or combinations of different types of networks may be used, including, but not limited to, the Internet, intranets, cable networks, cellular networks, landline-based networks, or other communication mediums connecting multiple computing device to one another. For example, a wireless fidelity (WiFi) or Bluetooth network, as non-limiting examples, may facilitate communication at the point-of-sale between a user device 150 and one or more POS devices 170 at a merchant location, for example. Other embodiments may not involve a network and may, for example, provide features on a single device or on devices that are directly connected to one another, e.g., the third party device 180 may be directly connected to one or more POS devices 170.

The devices illustrated in FIG. 1 may include one or more processors configured to communicate with one or more memory devices and various other components or devices. For example, the service provider device 110 may include one or more processors 124 that are configured to communicate with one or more memory devices 132, one or more input/output (IO) devices 126, storage 128, one or more communication connections 130, and one or more data stores 131. The processor 124 may be implemented as appropriate in hardware, software, firmware, or combinations thereof. Software or firmware implementations of the processor 124 may include computer-executable or machine-executable instructions written in any suitable programming language to perform the various functions described herein.

The memory 132 may store program instructions that are loadable and executable on the processor 124, as well as data generated during the execution of these programs. Depending on the configuration and type of service provider device 110, the memory 132 may be volatile, such as random access memory (RAM), and/or non-volatile, such as read-only memory (ROM), flash memory, etc. The memory devices 154, 174, 184, and 194 associated with the user device 150, the one or more POS devices 170, the third party device 180, and the source device 190, respectively, may be the same or at least similar to the memory 132 in one embodiment.

The storage 128 may include removable and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 132 may include multiple different types of memory, such as static random access memory (SRAM), dynamic random access memory (DRAM), or ROM.

The one or more communication connections 130 may allow the service provider device 110 to communicate with other devices, e.g. POS devices 170, databases, user terminals, and various other devices that may exist on the one or more networks 105. The input/output devices associated with the POS device 170 may include, but are not limited to, a keyboard, a mouse, a scanner, a printer, an NFC reader/writer, user biometric devices, or other IO devices. The input/output (“IO”) devices associated with the service provider device 110 as depicted via the input/output (I/O) devices 126 may enable a user to interact with the service provider device 110 to perform various functions, such as a create promotional content, as a non-limiting example. Such IO devices may include, but are not limited to, a keyboard, a mouse, a pen, a voice input device, a touch input device, a display, camera or imaging device, speakers, or a printer.

The one or more data stores 131 may store lists, arrays, databases, flat files, etc. In some implementations, the data store 131 may be stored in memory external to the service provider device 110 but accessible via the one or more networks 105, such as with a cloud storage service. The data stores 131 may store information associated with promotional content, such as sources and consumers of the promotional content, or other information that may facilitate the processes described herein.

One or more POS devices 170, the third party device 180, and the source device 190 may include some or all of the devices or components described above in association with the service provider device 110, several of which are discussed below.

The memory 132 of the service provider device 110 may include an operating system 134 and various applications and/or modules that may configure the service provider device perform various functions associated with tracking and analyzing promotional content, among other things. Example modules may include promotional content redemption modules 136, a data analysis module 148, a distribution module 149, and a user authentication module 146. Each of these modules may be implemented as individual modules that provide specific functionality associated with tracking and analyzing promotional content. Alternatively, one or more of the modules may perform all or at least some of the functionality associated with the other modules.

The one or more redemption modules 136 may manage the process of redeeming promotional content and may include, but are not limited to, a communication module 138, a verification module 140, a calculation module 142, and a store module 144 to perform such functionality.

The communication module 138 may enable the service provider device 110 to communicate with a POS device 170 over the network 105. Such communication may include receiving requests to redeem promotional content from the POS device 170 along with specific item(s) and services being purchased by the consumer and sending responses to the requests to a POS device 170. A request to redeem promotional content (redemption request) may be included in a message along with various other information, such as a unique identifier of the promotional content, a user device and/or user account associated with the promotional content, an identifier and/or description of one or more items identified in the promotional content, a purchase price of the one or more items, a discount amount or percentage to apply to the purchase price of the one or more items, and other information associated with redeeming promotional content. A response to a request to redeem promotional content may also include various information, such as an approval or denial status message, one or more requirements that must be met before a redemption request may be allowed, an adjusted purchase price (e.g., the resulting purchase price after applying a discount or savings on an item being purchased) or a discount to be applied by a POS device 170 to the purchase price (e.g. the discount or savings on an item being purchased) for an item indicated in promotional content, and information associated with promotional content that may be related to the redeemed promotional content, as non-limiting examples.

The communication module 138 may construct messages according to various formats to facilitate communication with other devices in FIG. 1. Examples of such formats may include, but are not limited to, extensible markup language (XML) format, CSV format, or other text format that may include one or more delimiters that may facilitate extraction of information from the messages.

The communication module 138 may utilize various protocols to enable communication with other devices. Examples of such protocols may include Hypertext Transfer Protocol (HTTP), Transmission Control Protocol/Internet Protocol (TCP/IP), socket-based protocols such as the WebSocket protocol, or other message formats and/or rules for exchanging information between computing devices to support communication between web-based program code and client-server-based program code, as examples. Additional formats may also include Simple Mail Transfer Protocol (SMTP) or other electronic mail formats for transmitting messages via electronic mail and one or more text formats for supporting e-mail via text messaging to or from a user device. In one embodiment, the communication modules 138 may include one or more application programming interfaces (APIs) that may utilize such protocols to facilitate communication between the service provider device 110 and the POS device 170, as well as other devices shown in FIG. 1.

The verification module 140 may verify requests to redeem promotional content. Such verification may be performed to ensure that the promotional content is valid and that one or more requirements for redeeming the promotional requirements have been met, as non-limiting examples. Each of these functions may involve the verification module 140 analyzing information in association with a redemption request, e.g., by the communication module 138, from the POS device 170 when a consumer attempts to redeem promotional content at a point-of-sale, according to one example.

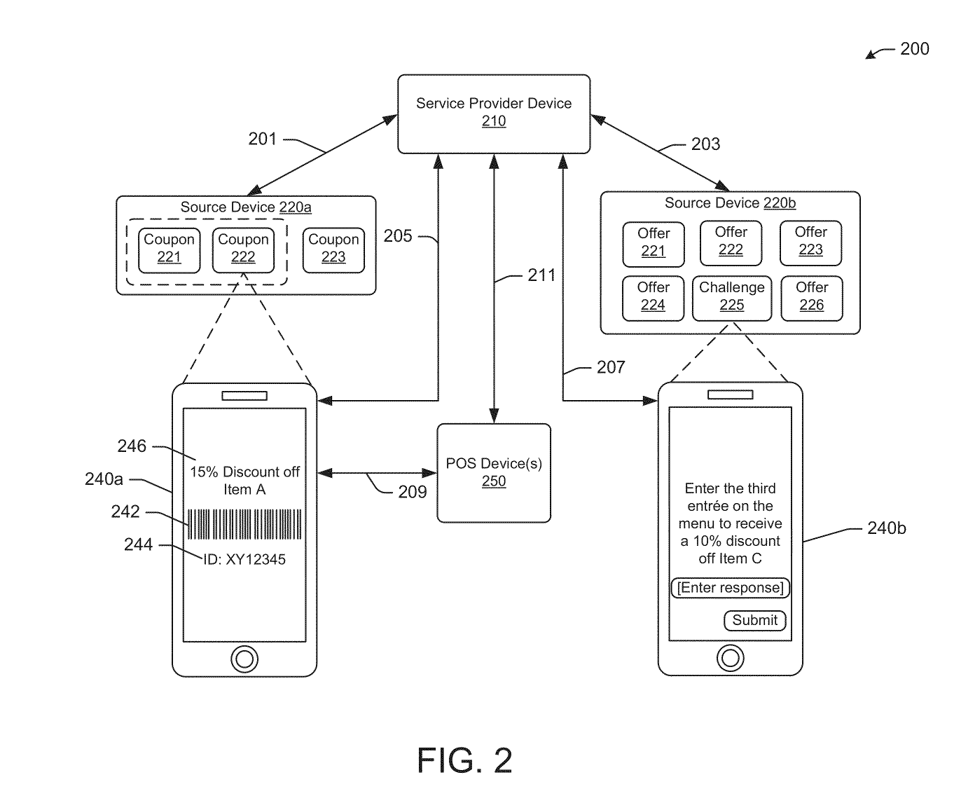

To determine whether promotional content associated with a redemption request is valid, the verification module 140 may compare information in the redemption request to information stored, e.g., in the data store 131. For example, a unique identifier for promotional content received by the POS device 170 at the point of sale may be compared to identifiers for one or more respective promotional contents stored at the service provider device 110. The identifiers for the one or more promotional contents may be stored in association with distributing promotional content to user devices. For example, when a user device selects promotional content, such as a banner advertisement, an identifier of the promotional content may be identified and stored prior to (or in conjunction with) distributing the requested promotional content to the user device. If the unique identifier received at the point of redemption of the promotional content matches the stored identifier (or another identifier previously stored), then the request to redeem the promotional content may be considered valid. If no match is found, then the request to redeem promotional content may be considered invalid. Various other types of information may be compared in other embodiments, some of which is described in association with FIG. 2.

The verification module 140 may further verify whether requirements to redeem promotional content have been met. Such requirements may be indicated in a redemption request and may include, but are not limited to, requiring that a particular item (or items) is being purchased, requiring that an additional item or items to be purchased along with a first item to receive a discount on the first item, requiring that a certain quantity of an item to be purchased to receive a discount on the items, or requiring that a successful response to a previous challenge be provided to receive a discount on an item. In one embodiment, if each requirement to redeem promotional content has been met, the verification module 140 may determine that the redemption request is valid. If one or more requirements have not been met, the verification module 140 may determine that the redemption request is invalid. In one embodiment, the verification module 140 may also verify that one or more items or services associated with promotional content are being purchased. According to this embodiment, a POS device (e.g., POS device 170) may send an indication that the one or more items or services are being purchased. After such a purchase occurs, e.g., after payment from a consumer or user is received, verified, and accepted, an additional message may be sent from the POS device 170 to the service provider 110. According to one example, promotional content may be considered redeemed after the one or more items or services associated with the promotional content have been purchased (e.g., payment received, verified, and accepted). The indication from the POS device 170 may include information associated with the one or more purchased items or services, such as a unique identifier associated with an item or service (e.g., a stock keeping unit (SKU) or other unique identifier), a description of the item or service, or other identifying information.

In addition to verifying requests to redeem promotional content, the verification module 140 may verify other types of information. For example, in embodiments in which a correct response to a challenge question or other interim requirement is required, the verification module 140 may verify whether a response to a challenge is correct. As another example, the verification module 140 may verify whether steps or actions required by a game or event have been met. To verify such requirements, the verification module 140 may access one or more databases or other storage mechanisms containing the correct answer to a challenge question or the steps required to complete a game, as examples, and may, if the correct response was provided, instruct a module (such as the distribution module 149 described below) to deliver the promotional content to a user device from which the correct response was received.

The calculation module 142 may determine a purchase price for an item associated with promotional content based at least in part on a discount amount associated with the promotional content, according to one embodiment. The purchase price determined at the point-of-sale may be provided to the calculation module 142 along with a unique identifier for the promotional content, etc., as part of a redemption request message. The calculation module 142 may identify a discount amount or percentage in the redemption request message by accessing information associated with the unique identifier for the promotional content as stored at the service provider device 110, according to one embodiment. The discount amount may be used to calculate the purchase price of the item. For example, an item that has a purchase price of $10.00 for which a 25% coupon or discount exists may be determined to cost $7.50. The reduced price may be sent from the service provider device 110 to the POS device 170, or an associated POS device, in one embodiment, or an amount to be deducted from the purchaser's total amount due may be sent from the service provider device 110 to the POS device 170, or an associated POS device, in another embodiment. The calculation module 142 may perform various other mathematical functions commensurate with a determination of the purchase price for an item associated with various redemption requests.

A store module 144 may store information received in a redemption request message, such as, but not limited to, a unique identifier for redeemed promotional content, the date and time of purchase of an item associated with the promotional content, an identifier of the POS device that received the request to redeem the promotional content (e.g., an Internet Protocol (IP) or a Media Access Control (MAC) address), and information associated with the location or store at which the promotional content was redeemed, such as the name, street address, store number, etc. In some embodiments, the store module 144 may also store information associated with the distribution of promotional content, such as a unique identifier uniquely identifying the promotional content, a user device and/or user requesting the promotional content, a URL associated with a website location from which the promotional content was identified and/or received, and various other information associated with the promotional content, user device and/or user utilizing the promotional content, and the source at which the promotional content was identified or received. In one example, a source device 190 may capture such information and provide it to the service provider device 110 where it may be stored. Additionally and/or alternatively, the source device 190 may store such information.

The data analysis module 148 may analyze stored information associated with promotional content to make a number of determinations, including, but not limited to, determining a target list of consumers and/or sources of promotional content and determining promotional effectiveness associated with promotional content, which may include determining a return on investment. Each of these determinations may facilitate the development of a personalized, cost-effective process for generating and distributing promotional content.

The data analysis module 148 may determine a target list of user devices (or users) to which to distribute promotional content. To make such a determination, the data analysis module 148 may identify user devices that have previously redeemed certain promotional content. Such promotional content may be targeted for future distribution to the same user devices, whereas content that was not redeemed by the user devices may not be targeted for future distribution. In one embodiment, a threshold number of redemptions may be utilized to determine whether a user device should be targeted for future distributions of the promotional content. If the threshold is met or exceeded, promotional content may be distributed to the user device that redeemed the promotional content, whereas the user device may not be targeted if the threshold is not met, according to one embodiment. Additional criteria may be used in other embodiments to target a list of user devices to which to distribute promotional content. Such criteria may include, but is not limited to, the size of the distribution population, the demographics of users associated with the user devices, the location of the user devices, the purchasing behavior of the users, etc.

As an example of utilizing the location of user devices to target user devices, a Global Positioning System (GPS) location of a user device may be provided (e.g., via the user applications 156) to the service provider device 110 and utilized by the service provider device 110, e.g., the data analysis module 148, to identify promotional content based on such a location. For example, the data analysis module 148 may identify merchants that are located near the user device based on the GPS location of the user device. In one embodiment, the data analysis module 148 may access GPS information associated with various merchants, or other entities, and compare such locations to the GPS location of the user device to identify merchants or other entities located within a certain range or distance of the user device (which may be a predefined threshold such as within one square mile, two blocks, etc.). In one embodiment, promotional content associated with merchants or other entities that are near the GPS location of a user device may be sent to the user device.

Numerous opportunities may exist to capture a user's GPS location information and subsequently distribute promotional content based on the GPS location information. One such opportunity may occur in response to a user device 150 selecting promotional content via a website provided by a source device 190. For example, when a user utilizes a user device 150 to click on a website link associated with promotional content, a source device 190 may redirect the user device 150 to the service provider device 110, where the data analysis module 148 may capture the GPS information of the user device 150 and identify promotional content based on the GPS location of the user device 150. Another opportunity to capture GPS location information and distribute promotional content based on the GPS location may occur in response to a user authenticating at the service provider device 110, e.g., via the authentication module 146. Additionally, other opportunities in which a user device 150 communicates with a source device 190, a POS device 170 associated with POS device 170, and/or service provider device 110 may present an opportunity for the data analysis module 148 to identify promotional content for the user device 150 based on its GPS location.

Additionally, the data analysis module 148 may identify promotional content that is related to previously redeemed promotional content and further target the related promotional content for distribution to user devices. To identify such related promotional content, the data analysis module 148 may search for certain keywords or terms in stored promotional content. For example, if a user previously redeemed promotional content to purchase a particular brand of carbonated beverage, the brand of the beverage, the manufacturer of the beverage, and type of beverage (e.g., carbonated), as well as other criteria, may be used to search stored promotional content. As a result of the search, the data analysis module 148 may determine that a different flavor of the same type of beverage, manufactured by the same manufacturer, is related promotional content and may subsequently distribute the related promotional content to a user device that previously redeemed the promotional content associated with the original beverage purchase. Numerous other techniques may be utilized in other embodiments to identify related promotional content.

In certain embodiments, related promotional content may be distributed to a user device as a list of promotional contents, at least some of which may be locked. As a user redeems promotional content, one or more additional promotional contents may be unlocked and subsequently redeemed.

The data analysis module 148 may also target certain sources (or source devices) of the promotional content. As used herein, a source may include a device, such as a web server, at which a user device identified promotional content. The source may not, in some embodiments, distribute the promotional content. For example, the source may include a banner advertisement or link that redirects a user device to another device (e.g. third party device 180 or service provider(s) 110) to receive the promotional content. Thus, according to one embodiment, the source may be considered the source by virtue of a user identifying promotional content at the source (e.g., source device 190), whether or not the user receives the promotional content from the source directly or from another device (e.g., as a result of the source redirecting the user to another device to receive the promotional content). The data analysis module 148 may target certain sources based, in part, on an amount of a redeemed promotional content that was received from (or identified at) the source. For example, a threshold amount may be used in one embodiment such that sources that are associated with a number of redemptions greater than the threshold may be used for future distributions of promotional content and/or related promotional content.

The data analysis module 148 may also determine a return on investment (ROI), or profitability associated with contributing capital to generate and distribute promotional content, in one embodiment. To determine an ROI, the data analysis module may identify costs associated with providing promotional content to users and revenue associated with redemptions of the promotional content. Total costs may be subtracted from total sales to determine a net profit, which may be divided by the total cost to determine an ROI. An ROI may indicate an effectiveness of promotional content, or which promotional content captured consumers' attention to the extent that the promotional content was actually redeemed (and not just downloaded from a source or distributor website and viewed). Based on the ROI, merchants, distributors, or other entities may utilize the ROI to focus their efforts on certain promotional content and/or sources of the promotional content, in certain embodiments. In one example, an ROI above a certain threshold or percentage may be used to determine a target list of user devices (or users) and/or sources (e.g., source devices) of promotional content. As another example, the cost to produce promotional content may be divided by the total number of redemptions of the promotional content to determine a cost per redemption of the promotional content. A cost per redemption may be compared for each promotion distributed to determine which promotion may be more effective.

The distribution module 149 may distribute promotional content to one or more user devices and/or one or more sources of promotional content, such as web servers that may distribute the promotional content to user devices. Such distribution may be based at least in part on determinations of targets for receiving promotional content, e.g., by the data analysis module 148. In one embodiment, the distribution module 149 may receive requests from a source device to distribute promotional content to a user device. Such requests may be received in association with a link or redirection from the source device to the distribution module 149 upon a user selecting a link or banner advertisement displayed on the source device 190, as an example.

In some embodiments, prior to distributing promotional content, the distribution module 149 may request that a user authenticate, e.g., via the authentication module 146, by supplying a user name and password to access the promotional content. In one embodiment, if the authentication is successful, then the user may receive the promotional content. If the authentication fails, a user may be prompted to enter certain information before receiving the promotional content. Examples of such information may include, but are not limited to, a user name and password for future authentication by the user authentication module 146, demographic information, a user's interests or preferences for certain promotional content or items, etc. Users may not be required to authenticate to receive promotional content in some embodiments.

The distribution module 149 may also generate promotional content. Such promotional content may be generated for a manufacturer, merchant, or other entity and may include an identifier, description, discount percentage or amount, expiration date, or other requirements for redeeming the promotional content. In other examples, the distribution module 149 may generate one or more challenges that may require a correct response to receive promotional content. The verification module 140, as described above, may determine whether the response is valid and may subsequently instruct the distribution module 149 to deliver the promotional content.

The one or more third party device 180 may include devices associated with merchants, manufacturers, or entities that may generate promotional content. A third party device 180 may include a processor 182 configured to execute computer-executable instructions in a memory 184, which may store one or more third party applications 186. The third party applications may generate the promotional content and communicate it to other devices, such as the service provider device 110 or source device 190, for distribution to user devices 150.

The one or more source devices 190 illustrated in FIG. 1 may host a website that provides a link or reference to promotional content for user devices. A source device 190 may distribute promotional content to user devices, in one embodiment, or may redirect user devices to another device (e.g., the service provider device 110) via a banner advertisement to obtain the promotional content, according to one example. The distribution device may include a processor 192 configured to execute computer-executable instructions in a memory 194, which may store one or more distributor applications 196 for performing the above described functions.

The one or more user devices 150 may include a processor 152 configured to execute computer-executable instructions in a memory 154, which may store various user applications 156. Such applications may include, but are not limited to, a promotional content processing module 160 and a browser 162.

The promotional content processing module 160 may receive promotional content and process the promotional content for display by a user utilizing the device 150. Such processing may include formatting the promotional content for display on a screen that is suitable for the device 150. For example, a different formatting may be required for a display associated with a handheld device than that required for a display for a desktop device. Other processing functions may be performed in other embodiments, such as, but not limited to, ranking or ordering multiple promotional contents for presentation based on user preferences for promotional content, for example, which may be defined in a configuration on the device 150 accessible by the promotional content processing module 160 or at a remote device, such as the service provider 110, which may also be accessible by the promotional content processing module 160.

A browser 162 may include program code that provides a web-based interface for performing various functions associated with promotional content. Such functions may enable a user to, among other things, search for promotional content, display promotional content to a screen associated with the user device, interact with promotional content, and present promotional content to one or more POS devices, such as the one or more POS devices 170, for redemption. For example, the browser 162 may enable a user to enter keywords or search terms to identify promotional content associated with the keywords or search terms. The browser 162 may further output received promotional content to a display 164 to render a presentation of the promotional content. The presentation of promotional content may conform to a format determined by the promotional content processing module 160 (as described above), in one embodiment.

A user may interact with multiple promotional contents stored on a user device, for example, by selecting and displaying certain of the promotional content for viewing and/or redemption. The selection of the promotional contents may be performed in conjunction with unlocking, or making available, promotional content related to promotional content that was previously redeemed. In examples in which promotional content may be unlocked, or made available to a user on a user device 150, the multiple promotional contents may be distributed to a user device together and stored on the user device 150. A user may be able to view the multiple promotional contents but may only be able to redeem those promotional contents that have been unlocked or otherwise made available, according to one embodiment. As promotional content is redeemed, other promotional content may be unlocked or made available such that a user may redeem them as well, in one example.

In some embodiments, rather than utilizing a browser 162, the user device 150 may include one or more client-side applications as part of the user applications 156 that may communicate with one or more server-side applications (e.g., in a client-server environment), to perform the functions performed above by the browser 162. Such client-side applications may also output promotional content according to a format to the display 164 to render a presentation of the promotional content.

The one or more POS devices 170 may include devices configured to receive information at the point-of-sale, for example, at a merchant location or other location of a provider of goods and services. Non-limiting examples of such devices may include a computing device 170a and a scanning device 170b, shown in FIG. 1, for calculating a total amount due for items or services and receiving input associated with the items or services, among other functions. A POS device 170 may include a processor 172 configured to execute computer-executable instructions in a memory 174, which may include one or more POS applications 176. The one or more POS applications 176 may perform various functions to facilitate the tracking and analysis of redeemed promotional content. For example, a POS application 176 may verify the consumption (e.g., the purchase, use, lease, winning, listening, etc.) of one or more items or services associated with promotional content. Such verification may include the POS application 176 verifying that a payment from a consumer or user was received and accepted, for example, by a financial institution associated with a payment method utilized by the user to redeem promotional content.

The one or more POS applications 176 may further include a communication module that may enable the POS device 170 to receive information (e.g., promotional content sought to be redeemed and responses to requests to redeem promotional content, etc.) from various devices, such as a user device 150 and a service provider device 110, respectively. The communication module may also enable the POS device 170 to send information (e.g., information associated with requests to redeem promotional content, and/or transaction data for transactions that include promotional content) to other devices, such as the service provider device 110. Such communication may occur via one or more APIs installed at the POS device 170 to configure the POS device 170 to communicate with other devices. In one embodiment, such communication may include one or more of the APIs establishing a connection with the service provider device 110 and subsequently sending redemption request information to the service provider device 110. In one embodiment, a different API may exist for each type of POS device 170 so that the various types of POS devices 170 may be properly configured to communicate with the service provider device 110.

The above examples are not meant to be limiting. Many more examples may exist in other embodiments. While various functions are described above with respect to particular devices, it is understood that these functions may be distributed in many ways across the devices. For example, functionality provided by the third party devices 180 and/or the source devices 190 may be provided by the service provider device 110.

FIG. 2 illustrates an example schematic diagram of a process for distributing promotional content, according to one embodiment of the disclosure. In one embodiment, the process may be implemented by various devices, such as, but not limited to, a service provider device 210, source devices 220a and 220b, user devices 240a and 240b, and one or more POS devices 250. Although a certain number of each of these devices is shown in FIG. 2, more devices may exist in other embodiments. For example, any number of user devices capable of receiving promotional content may communicate with any number of distribution devices, such as web servers hosting websites, to receive promotional content.

Various promotional content may be stored at the source devices 220a and 220b for accessing by user devices 240a and 240b, according to one embodiment. In another embodiment, the same promotional content may be stored at another device, such as the service provider device 210, and the source devices 220a and 220b may redirect users (e.g., via a web page hyperlink embedding a URL directed to a remote device) to the service provider device 210 (via connections 201 and 203, respectively), or other device storing promotional content, to receive a distribution of the promotional content.

In one embodiment, promotional content stored on a source device may be the result of targeted efforts based on data analysis techniques, e.g., by the data analysis module 148 in FIG. 1, to personalize and/or more effectively distribute promotional content. For example, some source devices may receive promotional content associated with a particular manufacturer, for example, by virtue of users redeeming promotional content associated with the manufacturer. Promotional content may be targeted for certain sources or distributors based on any one or a combination of factors, as described in certain embodiments herein. The difference in promotional content stored on source device 220a and 220b may be the result of such targeting. For example, source devices 220a and 220b may both include coupons 221-223, while only source device 220b may include coupons 224 and 226, and challenge 225. Thus, different source devices may store the same or different promotional content.

Promotional content may include details to support price reductions or savings on items. Such details may include a unique identifier uniquely identifying the promotional content, an identification of an item or service for sale, a description of the item or service, a price savings amount or percentage of the item or service, a quantity of an item applicable to the price savings, a location where the promotional content may be redeemed, an expiration date for redeeming the promotional content, etc. Such information may be included in promotional content that is distributed to a user device, for example, such that when the user device attempts to redeem the promotional content, a device, such as a POS device 170 in FIG. 1, may identify the information.

In certain embodiments, promotional content may be linked to or associated with other promotional content such that, when one promotional content is redeemed, associated promotional content may be unlocked or made available for use by a consumer who redeemed associated promotional content. In this way, a user may be rewarded with additional promotional content based on the user's purchase behavior. In source devices 220a, the dotted box encircling coupons 221 and 222 may indicate that coupons 221 and 222 are linked. Thus, if coupon 221 is redeemed, coupon 222 may be unlocked for future redemption by the user.

A response message to a request to redeem coupon 221, for example, by the service provider device 210, may be received by one or more POS devices in various forms. For example, a location of where a user may access coupon 222 may be provided to one or more POS devices, such as a register (via connection 211), and subsequently printed on a receipt for the user. Such a location may indicate, as a non-limiting example, a URL address that a user may visit to obtain additional promotional content that may be of interest to the user by way of the promotional content's relationship to redeemed promotional content. As another example, such a location or other information may be displayed on a screen associated with a POS device that is viewable by a user. In other examples, linked promotional contents may be distributed to a user device and stored thereon. In these embodiments, the service provider device 210 may provide a response message to the user device 240a (e.g., via the communication module 138) (over connection 205), directly or indirectly (e.g., via POS device 250), in response to a successful redemption of coupon 221, that may unlock coupon 222 on the user device 240a.

User devices 240a and 240b may be configured, e.g., via one or more user applications 156, to receive promotional content from the source devices 220a and 220b, as indicated by the respective triangular-shaped dotted lines emanating from the source devices to the user devices. Although FIG. 2 shows user device 240a receiving promotional content from source device 220a, and user device 240b receiving promotional content from source device 220b, either of these devices may receive promotional content from either of the source devices or other source devices.

The user device 240a, e.g., via the browser 162 in FIG. 1, may display a link, such as a web hyperlink, associated with coupon 221, coupon 222, and/or coupon 223, in one example. Upon selecting a link associated with coupon 222, for instance, a user utilizing the user device 240a may receive the coupon 222 from the source device 220a or the service provider 210. Other types of promotional content, such as a challenge requiring a correct response to a question before providing promotional content, may also be received. For example, the user device 240b may receive a challenge 225. The challenge 225 may present an inquiry or game to a user utilizing the user device 240b. The challenge, among other things, may test a user's knowledge or loyalty to a particular merchant, for example, by presenting an inquiry tailored to the merchant's business. For example, as shown in FIG. 2, one such challenge may include asking a user to provide the third entrée on the menu at a particular merchant to receive a discount off item C. If the user provides the correct answer (e.g., as determined by the verification module 140 in FIG. 1) (via connection 207), then the user may receive the promotional content, in this case the 10% discount off of item C.

When a user selects coupon 222, for example, information associated with the coupon 222, the user device 240a, and the source device 220a may be sent from the source device 220a to the service provider device 210 (via connection 201), wherein the information may be captured and stored, according to one embodiment. Information associated with a user device may include, but is not limited to, a unique identifier uniquely identifying the user device, such as an International Mobile Equipment Identity (IMEI) number, Media Access Control (MAC) address, or other identifier that may uniquely identify a user device. In one embodiment, the unique identifier for a user device may be utilized to determine a phone number and/or a user who may utilize the user device. The phone number and/or user identification may be determined by accessing such information as stored by one or more sources of such information.

Information associated with the coupon 222 may include, but is not limited to, an identifier uniquely identifying the coupon 222, a description of an item associated with the coupon 222, a savings or discount amount or description, an expiration date, one or more requirements for redeeming the coupon 222, etc. Information associated with the source of promotional content may include, but is not limited to, a URL associated with a website address from which the promotional content was received. The URL may indicate a domain name that corresponds to a manufacturer, merchant, or any entity operating a website that may provide promotional content to users.

In one embodiment, prior to distributing promotional content, a user may be required to authenticate by providing an existing user name and password, or additionally and/or alternatively, the user may be required to provide various information such as, but not limited to, a user name and password to establish a user account, demographic information (e.g., name, home address, income, age, sex, race), the user's interests or preferences for certain promotional content or items, etc. By obtaining such information, certain embodiments herein may leverage personalized information about a user to tailor promotional content offers based on the user's preferences or historical purchase behavior, as non-limiting examples.

Upon selecting a link (e.g., a web page hyperlink) associated with coupon 222, the user device 240a may receive coupon 222, which may include a unique identifier for the coupon 222. A user application running on the user device 240a, e.g., the user applications 156 in FIG. 1 which may include a dedicated application, may display the coupon 222. The coupon may be displayed on the device 240a and subsequently displayed according to various formats, as described above. According to one format, a bar code 242 representing a value for the unique identifier of the coupon 222 may be displayed. Other formats may utilize a Quick Response (QR) code or other types of codes that may be manually input. The bar code 242 may be scanned by a POS device 250 to receive the unique identifier and other information associated with the coupon 222. Other formats may include a text representation 244 of the unique identifier along with (or without) a bar code 242. A description 246 of the coupon 222 may also be displayed, in some embodiments.

In one embodiment, in association with a user device requesting promotional content, the user device may receive an identification of the promotional content, an identification of the source at which the user device identified the promotional content, and an identification of the user device that received the promotional content. In one embodiment, such information may be stored in a QR code, bar code, or other coded format such that when a POS device scans the QR code, bar code, etc., it may receive the identification of the promotional content, the source, and the user device. In another embodiment, such information may be stored as an NFC identifier whereby the user may tap an NFC receiver associated with a POS device so that it may receive the identification of the promotional content, the source and the user device.

For example, a user may utilize the user device 240a to request redemption of the promotional content at the POS device 250 (via connection 209). In some embodiments, paper may be used instead of a display to present promotional content. The paper may include at least a portion of the information that is displayed on a display associated with the user device 240a, or additional information, according to various embodiments. In one embodiment, the POS device 250 may embody the POS device 170 in FIG. 1. A number of input mechanisms may be utilized to enable the POS device 250 to receive information from user devices, such as the user device 240a. Examples of such mechanisms may include, but are not limited to, a barcode scanner as mentioned, a card scan or swipe, near field communication (NFC), reading various biometric data (such as fingerprints, voice input, retinal scan, etc.), mouse or keypad entry, and touch screen input.

Upon receiving information from the user device 240a, the POS device 250 (e.g., via API program code associated with the POS applications 176), may establish a connection 211 with the service provider device 210 and send the unique identifier of the coupon 222, the source device 220a, the user device 240a, and/or other information, to the service provider device 210 for processing (e.g., by the verification module 140). In one embodiment, such information may be sent as a message requesting redemption of the promotional content.

Upon receiving the request message and identifying the unique identifier of the promotional content therein, the service provider device 210 may search for the unique identifier among multiple unique identifiers associated with multiple respective promotional contents. The multiple identifiers, along with other information identified above, may have been stored at the service provider device 210 in association with the service provider device receiving a request, or an indication of a request, for promotional content. If a match is determined between the unique identifier in the request message and a stored unique identifier (e.g., as determined by the verification module 140), then a determination may be made that the redemption request is valid, according to one embodiment. If it is determined that a match does not exist, then a determination may be made that the redemption request is invalid.

In other embodiments, various other information associated with promotional content requested for redemption may be utilized to determine whether a redemption request is valid. For example, the item or items being purchased, date of expiration, the location of the store, merchant or place that the promotional content is being presented for redemption, or one or more other requirements that must be met before the promotional content is redeemed, etc., may be compared to determine validity. In the present example in FIG. 2, if a user is attempting to purchase Item B (as determined by the POS device 250 at the point-of-sale) instead of Item A, as identified in coupon 222, a request to redeem coupon 222 may be invalid and therefore denied (e.g., as determined by the verification module 140). As another example, in some embodiments, a user device or user account that received promotional content (as determined by the service provider device 210 during a request for the promotional content) may be compared to the user device or user account that is attempting to redeem the promotional content. According to this example, one or more restrictions may be placed on which users may redeem certain promotional content to, for example, reward certain users and not others for their previous redemptions. In another example, a GPS location associated with a user device (as captured by the POS device 250 and sent to the service provider device 210, in one example) may be verified to confirm that a user is located at the proper merchant, store, or other location for redeeming promotional content.

In one embodiment, a POS device 250, after receiving an indication from the service provider device 210 that the request to redeem promotional content is valid, may allow the purchase of one or more items associated with the promotional content to occur. Upon the POS device 250 verifying that the purchase occurred or is occurring, the POS device 250 may send an indication of the purchase (along with information identifying the item or service) to the service provider device 210, where the information, or an indication that the purchase of one or more items associated with promotional content occurred or is occurring, may be stored and/or further utilized as described below.

The service provider device 210, e.g., via the store module 144, may store information associated with validating a request to redeem promotional content, as well as information associated with purchased items or services associated with the promotional content. Such storing may provide an indication that promotional content was redeemed. Examples of information that may be stored to provide the indication may include, but are not limited to, the unique identifier for the promotional content, a date and time of purchase, the item or items that were purchased in the transaction that the promotional content was redeemed, a store identification and/or location at which the redemption occurred, and/or an identification of the POS device receiving the redemption. As another example, an indicator in a database or other storage mechanism may be updated to indicate that promotional content associated with a particular unique identifier was redeemed. As described, the stored information may be analyzed to make a number of determinations, such as determining a targeted list of users and/or sources for receiving the promotional content and determining an effectiveness of promotional content based on return on investment (ROI), as non-limiting examples.

Various criteria may be utilized to determine a target list of user devices. In the present example, a targeted list of user devices for receiving future distributions of coupon 222 may include user device 240a by virtue of user device 240a previously redeeming coupon 222. User device 240a may also receive related promotional content based at least in part on the redemption of coupon 222. For example, coupon 221 may be related to coupon 222, as indicated by the dotted box in FIG. 2 encircling both coupons. Upon user device 240a redeeming coupon 222, coupon 221 may be unlocked or otherwise made available such that it may thereafter be redeemed by user device 240a. Device 240a may therefore be targeted for future distributions of coupon 221 as well. Additional information that may be utilized to target user devices for certain promotional content may include the results from searches using various search terms or keywords. As another example, the location of a user device may also be utilized to determine which promotional content to distribute to a user device. For example, a location associated with a user device, such as a GPS location, may be determined (e.g., by the service provider device 210) along with merchants in a vicinity near the user device. By virtue of its location, the user device may receive promotional content associated with merchants in the vicinity of the user device, according to one embodiment. Various other criteria may be used to target user devices in other embodiments. In one example, location information, such as GPS information, may be received by the service provider device 210 from another device (not shown) that may be configured to request and receive such information. Such a device may send the location information over one or more networks to the service provider device, where the communication module 138, for example, may receive the information.

The above example is only one non-limiting example. Many more examples that may involve fewer or more devices, different types of devices, and/or different types of promotional content, for example, may exist in other embodiments.

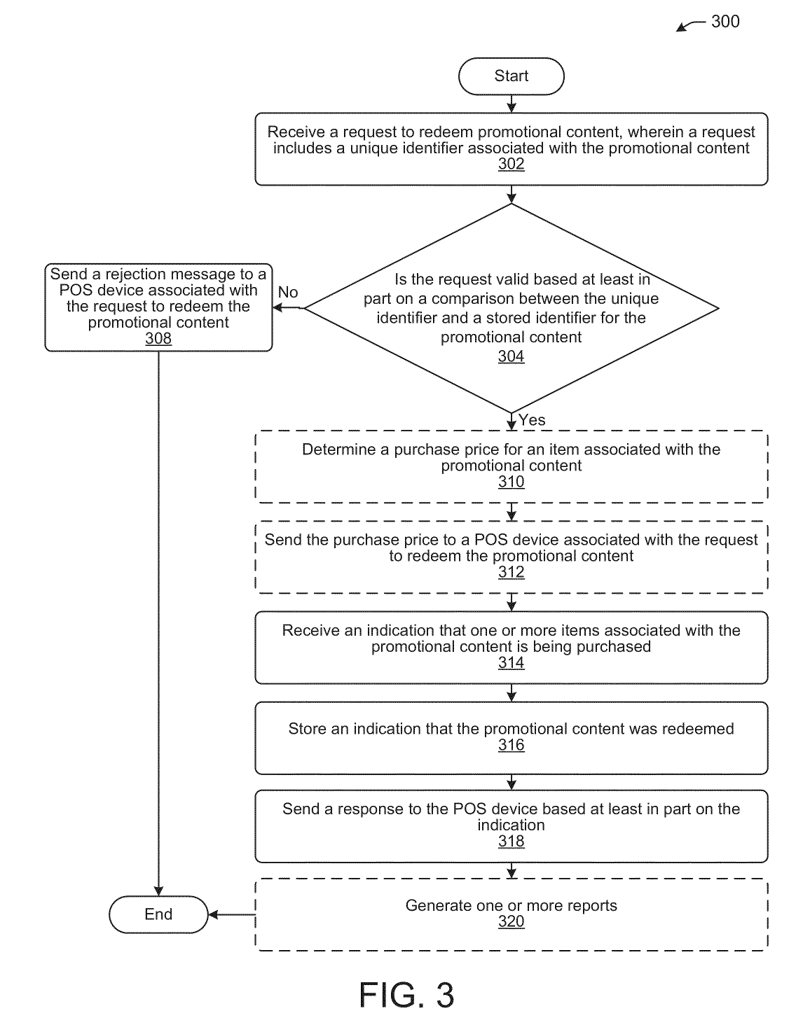

FIG. 3 illustrates an example flow diagram 300 of a process for facilitating the redemption of promotional content, according to one embodiment of the disclosure. The steps in the example flow may occur concurrently or be in a modified sequence as this is a non-limiting example flow. The example flow diagram may be performed by the service provider device 110 in FIG. 1, in one embodiment. At block 302, a request to redeem promotional content may be received, e.g., via the communication module 138. The redemption request may be verified, e.g., by the verification module 140, to determine whether the redemption request is valid, at block 304. The verification may include comparing information associated with the distribution of promotional content, which may be stored at a central device such as the service provider device 110, to information associated with the redemption of the promotional content, which may be received by the service provider device 110 in a redemption request message at the point of sale, in one embodiment. In one embodiment, a determination may be made whether the redemption request is valid based at least in part on a comparison between a unique identifier associated with promotional content received from a POS device and a stored identifier for the promotional content identified in association with the distribution of the promotional content. In other embodiments, the verification may also verify whether one or more requirements have been met before the promotional content may be redeemed, such as verifying that the promoted product or service is being consumed, e.g., purchased. If a mismatch between compared information exists or one or more requirements have not been satisfied, then the redemption request may be determined to be invalid.

If the redemption request is determined to be invalid, then the redemption request may be rejected and a corresponding message may be sent, e.g., via the communication module 138, to a device such as a POS device that may have received the redemption request, or a device in communication with such a POS device, at block 308. Upon receiving the rejection message, the POS device, or associated device, may not permit the redemption of the promotional content, and hence a purchase of an associated item at a discount, to occur. If the request to redeem promotional content is valid, then a value associated with the promotional content may be determined, e.g., by the calculation module 142, at block 310. For example, for a coupon that provides 10% savings off of a $20 item, the determined price may be $18 for that item, or the total price less the cost savings percentage. The determined value or the computed discounted amount, as examples, may be sent to the POS device that received the redemption request, or another device associated with the POS device (at block 310), and the redemption of the promotional content may occur.

In accordance with the redemption of the promotional content, a POS device (e.g., via the POS application 176) may verify that one or more items or services indicated in promotional content are in the process of being consumed (e.g., purchased, used, leased, won, listened to, etc.) and send an indication of the consumption (at block 310), which may be received by the service provider device, at block 312, in one embodiment. Such an indication may include information identifying the item or services, as well as other information, such as, but not limited to, the date and time of the purchase processing, an identifier of the POS device that verified the processing of a purchase of the item or service associated with the promotional content (e.g., an Internet Protocol (IP) or a Media Access Control (MAC) address), information associated with the location or store at which the promotional content was redeemed, such as the name, street address, store number, etc.

A response message may be sent to the POS device at block 316. In one embodiment, such a response message may be sent in response to receiving the indication and may include a confirmation that the indication of the purchased item was received, information associated with one or more additional promotional contents that may be related to the redeemed promotional content (such as a URL that may be visited by a user to access the additional promotional content), a brief message that may be presented to a user, etc. In another embodiment, at least a portion of the information included in the response message, such as the one or more additional promotional contents, may be included in the response message that may include an adjusted price for an item associated with promotional content requested for redemption.

Information associated with the redemption request and the purchase of an item or service associated with the promotional content, as non-limiting examples, may be stored, e.g., by the store module 144, at block 314. In one embodiment, an indication may be stored to indicate that promotional content was redeemed. Such an indication may include setting a flag, a field (e.g., database field), Boolean operator, or other indicator that, when set, may indicate that promotional content associated with the indication was redeemed. Numerous other techniques to indicate that promotional content was redeemed may exist in other embodiments. The stored information may be utilized to generate one or more reports, e.g., via the data analysis module 148, at block 318. Examples of such reports may include a return on investment (ROI) report or a report that identifies a targeted list of user devices or users, as well as sources or distributors of promotional content, as non-limiting examples.

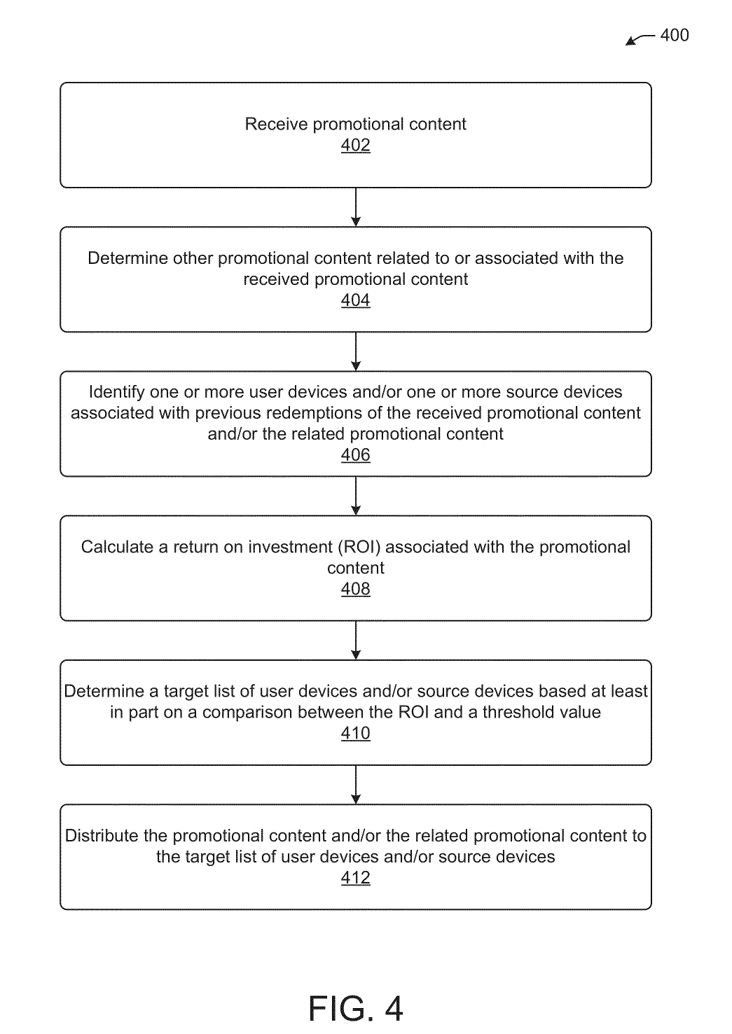

FIG. 4 illustrates an example flow diagram 400 of a process for determining one or more target lists for distributing promotional content, according to one embodiment of the disclosure. The example flow diagram may be performed by the service provider device 110 in FIG. 1, in one embodiment. Processing may begin at block 402, where promotional content may be received. Promotional content may be received from devices associated with various providers, such as third party devices 180 in FIG. 1. In one embodiment, promotional content may be generated and/or distributed by the service provider device 110. In one embodiment, the promotional content received at block 402 may be promotional content associated with a request to redeem the promotional content, rather than generated promotional content that may not yet have been distributed or redeemed. In either of these instances, promotional content may be identified and utilized to determine target lists as described herein.

At block 404, promotional content related to the received promotional content may be identified. Such promotional content may be identified by searching keywords in descriptions or other information associated with promotional content, e.g., via the data analysis module 148, as stored in a data store, e.g., data store 131. By identifying related promotional content, a user device may receive a distribution of a broader array of promotional contents in addition to promotional content that was previously redeemed.

User devices (or users) and/or source devices associated with previous redemptions of the received promotional content and the related promotional content may be identified, at block 406. In one embodiment, the user devices may be identified by determining user devices that redeemed the promotional content previously. One or more sources (e.g., source devices) associated with the promotional content may be determined by identifying source devices from which redeemed promotional content may have been obtained.

At block 408, a return on investment (ROI) for the promotional content may be calculated as described above. The ROI may be utilized to determine a target list of user devices (or users associated with the user devices) and/or sources of the promotional content such that more profitable or effective distribution of the received promotional content and related promotional content may be identified, at block 410. For example, user devices that redeemed a certain amount or percentage of the promotional content (e.g., above a threshold value) may be targeted for future distributions of the promotional content, and source devices associated with a number or percentage of redemptions for the promotional content above a certain threshold may also be targeted. The ROI calculation may associate a revenue with each redemption associated with a user device or the total number of redemptions associated with user devices associated with a source device and utilize such revenue in the ROI calculation, along with costs associated with the promotional content (e.g., production costs, distribution costs, etc.). An ROI associated with a user device or source device may be evaluated or considered to determine whether the user device or source device may be targeted for future distributions of the promotional content.

Techniques other than ROI may be utilized in other embodiments to determine target lists of user devices (or users) and source devices. Such techniques may rely on user location, demographics or a number or percentage of redemptions compared to a threshold, a ranking of the number of redemptions for each user device or source device in which a certain percentage (e.g., top 10% of user devices or source devices) may be targeted, a number or percentage of redemptions within a certain time period, or a number or percentage or redemptions for a certain price range of items or services, as non-limiting examples.

The promotional content and/or the related promotional content may be distributed to the service providers, targeted user devices, and/or source devices, at block 412.

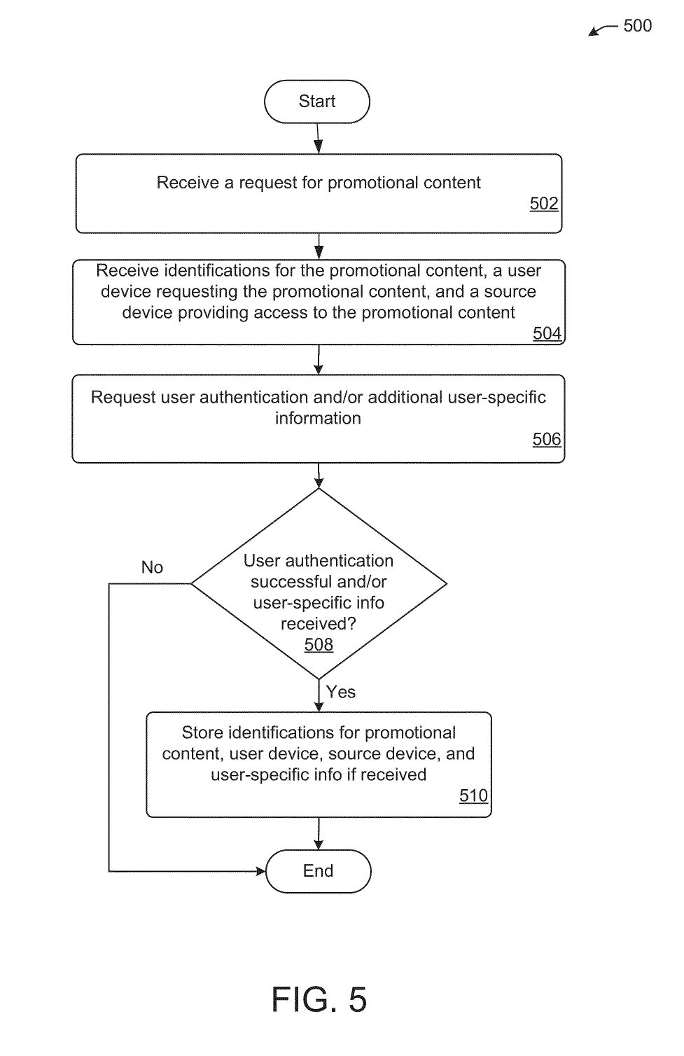

FIG. 5 depicts an example flow diagram 500 of a method for capturing information associated with requesting promotional content, according to an embodiment of the disclosure. The example flow diagram may be performed by the service provider device 110 or a third party device 180 in FIG. 1, in one embodiment. The method may begin at block 502, where a request for promotional content may be received. Various information may be received in association with receiving the request for promotional content including, but not limited to, an identifier associated with a user device requesting the promotional content, an identifier for the promotional content, and an identifier of the source device at which the user device identified the promotional content (e.g., a URL), at block 504.

At block 506, a request may be sent to a user utilizing the user device to authenticate by, for example, entering a user name or password that may have been established to allow the user to receive promotional content. Additionally and/or alternatively, various user-specific information may be requested, such as GPS location, demographic information, preferences for promotional content, etc. Such information may be utilized to select and distribute promotional content that may be of particular interest to the user.

A determination may be made at block 508 as to whether the user's access was authenticated or user-specific information was communicated to satisfy distribution criteria. If such information was provided, then the user-specific information received may be stored in association with the unique identifier for the promotional content and the user device, among other information, at block 510. If the user-specific information was not obtained or did not satisfy distribution criteria, then processing may end without storing user-specific information.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable code or program instructions. Likewise, some blocks of the block diagrams and flow diagrams may not necessarily need to be performed in the order presented, or may not necessarily need to be performed at all, according to some implementations.

These computer-executable code or program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system comprising:
at least one memory that stores computer-executable instructions; and
at least one processor configured to access the at least one memory, wherein the at least one processor is configured to execute the computer-executable instructions to:
store first information associated with a distribution of promotional content to a user device, wherein the first information comprises an identifier that identifies a source from which the user device received the promotional content;
receive, from one or more POS devices, a request to redeem promotional content, wherein the request comprises second information associated with the promotional content;
verify the request based at least in part on a comparison between at least a portion of the first information and at least a portion of the second information;
determine that the request is valid;
receive, from the one or more POS devices, a first indication that an item or service associated with the promotional content is being consumed; and
in response to receiving the first indication, storing at least a second indication that the promotional content was redeemed.

2. The system of claim 1, the at least one processor further configured to send a response based at least in part on the request.

3. The system of claim 2, the at least one processor further configured to determine an adjusted purchase price for the item or service, wherein the response comprises the adjusted purchase price.

4. The system of claim 2, wherein the promotional content comprises first promotional content and the response comprises a first response, wherein the at least one processor is further configured to:
determine one or more second promotional contents related to the first promotional content; and
send a second response comprising the one or more second promotional contents.

5. The system of claim 1, wherein the identifier comprises a first identifier, and wherein the at least a portion of first information further comprises a second identifier associated with the promotional content and a third identifier associated with the user device.

6. The system of claim 1, wherein the at least a portion of the first information comprises a first identifier of the promotional content and the at least a portion of the second information comprises a second identifier of the promotional content.

7. The system of claim 1, the at least one processor further configured to:
determine that the request is invalid when a match does not exist between the at least a portion of the first information and the at least a portion of the second information; and
send a response indicating that the request is denied.

8. The system of claim 1, the at least one processor further configured to:
determine one or more user devices or one or more source devices for receiving the promotional content based at least in part on historical redemptions of the promotional content; and
distribute the promotional content to at least a first portion of the one or more user devices or at least a second portion of the one or more source devices.

9. One or more computer-readable media storing computer-executable instructions that, when executed by at least one processor, configure the at least one processor to perform operations comprising:
receiving, from a user device, a first identifier identifying promotional content, a second identifier identifying a source at which the promotional content was identified, and a third identifier identifying the user device, wherein the first identifier, the second identifier, and the third identifier were received by the user device in association with the user device requesting the promotional content;
sending, to a service provider device, a request to verify the promotional content, the request comprising the first identifier, the second identifier, and the third identifier; and
receiving, from the service provider device, a status message based at least in part on the verification request.

10. The one or more computer-readable media of claim 9, wherein the status message comprises a purchase price for the item or service based at least in part on the discount.

11. The one or more computer-readable media of claim 9, the at least one processor further configured to perform the operation comprising identifying the first identifier, the second identifier, and the third identifier in a bar code or a Quick Response (QR) code displayed at the user device.

12. The one or more computer-readable media of claim 9, wherein the response comprises a first response, wherein the at least one processor is further configured to perform the operations comprising:
sending an indication that an item or service associated with the promotional content was purchased; and
receiving, in response to the indication, an indication of second promotional content related to the promotional content.

13. The one or more computer-readable media of claim 12, wherein the indication comprises a Uniform Resource Locator (URL) corresponding to a location from which the user device may receive the second promotional content.

14. A method comprising:
receiving, by a service provider system comprising one or more computing devices, from a user device, a request to receive promotional content;
determining, by the service provider system, a first identifier associated with the promotional content, a second identifier associated with the user device, and a third identifier associated with a source at which the user device identified the promotional content;
storing, at the service provider system, the first identifier, the second identifier, and the third identifier;
receiving, at the service provider system, a request to redeem the promotional content, wherein the request comprises a unique identifier identifying the promotional content;
verifying, by the service provider system, the request based at least in part on a comparison between the unique identifier and the first identifier;
receiving, at the service provider system, a first indication that an item or service associated with the promotional content is being consumed; and
in response to the first indication, storing, by the service provider system, a second indication that the promotional content was redeemed.

15. The method of claim 14, wherein the third identifier comprises a URL of a website address location of the promotional content, wherein the URL provides an indication of the source of the promotional content.

16. The method of claim 14, further comprising:
determining a target list of one or more user devices or one or more source devices for receiving the promotional content based at least in part on historical redemptions of the promotional content; and
distributing the promotional content to at least a first portion of the one or more user devices or at least second portion of the one or more source devices.

17. The method of claim 16, wherein determining the one or more source devices comprises determining a respective return on investment (ROI) for the one or more source devices, wherein the respective ROI is greater than a threshold value for the one or more sources devices on the target list.

18. The method of claim 16, wherein the target list of the one or more user devices is based at least in part on a respective Global Positioning System (GPS) location of the one or more user devices.

19. The method of claim 14, further comprising:
determining an adjusted purchase price for an item or service associated with the promotional content; and
sending a response comprising the adjusted purchase price.

20. The method of claim 14, wherein the promotional content comprises first promotional content, the method further comprising:
determining one or more second promotional contents related to the first promotional content; and
in response to receiving the first indication, sending an indication of one or more second promotional contents.

21. The method of claim 14, further comprising, in response to determining that a match does not exist between the unique identifier and the first identifier, sending a response indicating that the request is approved or denied.
